(19) United States
(12) Patent Application Publication
(10) Pub. No.: US 2011/0224810 A1
(43) Pub. Date: Sep. 15, 2011

(54) HOME AND BUILDING AUTOMATION

(75) Inventors: Sylvain Dubois, Paris (FR); Joe Tom, Foster City, CA (US)

(73) Assignee: Spansion LLC, Sunnyvale, CA (US)

(21) Appl. No.: 12/723,590

(22) Filed: Mar. 12, 2010

(51) Int. Cl. G06F 17/00

(52) U.S. Cl. 700/90

(57) ABSTRACT

Systems (100) and methods (500) for controlling a household electronic device (HED). The HED (102, . . . , 114, 142) comprises a processing unit (302) configured to execute first device-control software operative for controlling the HED so that it performs a primary function using original values for a plurality of operating parameters. The methods involve receiving, at the HED, an active processing module (130, . . . , 140, 144, 146) configured to execute second device-control software. The second device-control software is operative for controlling the HED so that HED performs the primary function using a customized value for one or more of the operating parameters or performs a secondary function different than the primary function.

### BACKGROUND OF THE INVENTION

1. Statement of the Technical Field

The invention relates to home and building automation. More particularly, the invention relates to systems and methods for controlling appliances and/or consumer electronic devices in a home or other building (e.g., an office building, a retail store or an airport).

2. Description of the Related Art

There are many conventional home and building automation systems known in the art. The conventional home and building automation systems facilitate the automation of appliances and/or consumer electronic devices useful for an intended job (e.g., washing clothes, watering plants, making coffee, providing entertainment, etc. . . . ). For example, conventional home automation systems have typically been used to automatically or semi-automatically control the operations of lights, door locks, window locks, window shades/blinds, security and surveillance systems, appliances, thermostats, home theaters, radios, televisions, phone systems, intercoms, pet feeding devices, pool pumps, pool heaters, domestic robots, air conditioner systems and irrigation systems. The control of such home appliances and features is often based on the absence and/or presence of a person in the home, the day of the week, the time of day, the detection of a fire, the detection of a security breach and other factors.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary home automation system employing active processing modules that is useful for understanding the present invention;

FIG. 2 is a schematic illustration of an exemplary appliance having an active processing module disposed therein that is useful for understanding the present invention;

FIG. 3 is a block diagram of an exemplary circuit of the exemplary appliance of FIG. 2 that is useful for understanding the present invention;

FIG. 4 is a schematic illustration of an exemplary active processing module that is useful for understanding the present invention; and

FIG. 5 is a flow diagram of an exemplary method for controlling operations of an appliance or other consumer electronic device.

### DETAILED DESCRIPTION OF THE PREFERRED EMBODIMENTS

The present invention will now be described with reference to the attached figures, wherein like reference numbers are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The present invention generally concerns networking technologies for controlling household appliances and/or consumer electronic devices in a home or other building (e.g., an office building, a retail store and an airport). In this regard, it should be noted that many initiatives have been promoted to develop low-cost networking technologies for controlling household appliances and/or consumer electronic devices in homes and other buildings. The success of such networking technologies wide adoption resides in open-standard interoperability. Today, a single industry-wide standard for such in-home or in-building networking technologies does not exist. As such, designers of such networking systems have to cope with multiple gateways to transmit messages around a home or building on several communication protocols and physical buses using wired or wireless transmissions. In order to enable the development of such networking systems, the present invention provides a low cost and flexible solution that is customizable to the particular requirements of each home or building. The present invention enables fast development time of new device-control applications using existing networking technologies at a minimum expense to manufacturers of household appliances and consumer electronic devices.

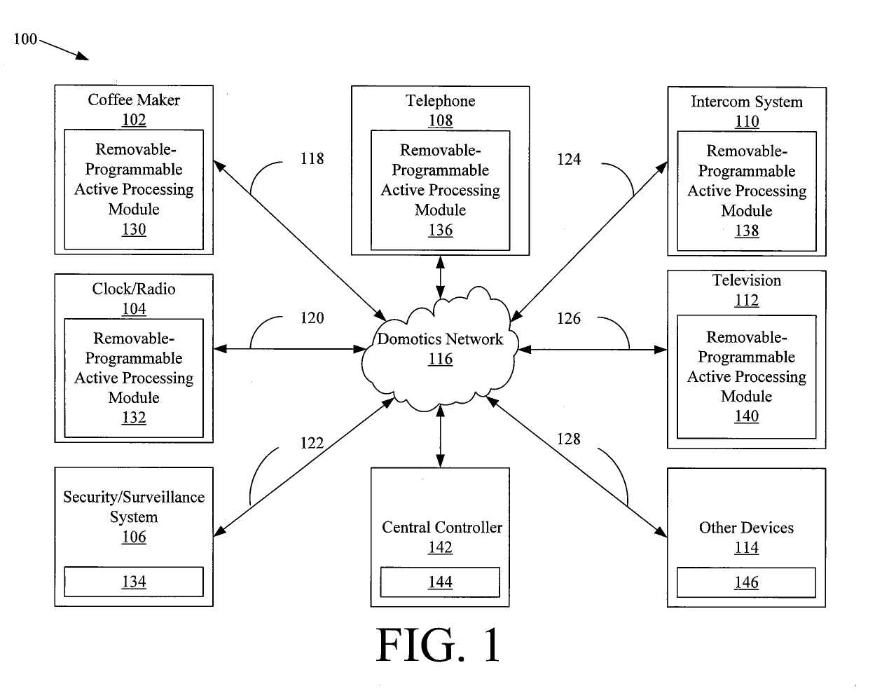

Referring now to FIG. 1, there is provided an exemplary home automation system 100 that is useful for understanding the present invention. As noted above, the present invention is not limited to automation applications within a home. The present invention can be used in various other applications, such as office automation applications and public building automation applications. However, the present invention will be described in relation to home automation applications for purposes of simplicity and illustrative convenience.

As shown in FIG. 1, the home automation system 100 comprises a plurality of household electronic devices (HEDs) 102, 104, 106, 108, 110, 112, 114, 142 communicatively coupled to a Domotics Network (DN) 116 via wired or wireless communication links 118, 120, 122, 124, 126, 128. Notably, the HEDs 102, 104, 106, 108, 110, 112, 114 can be manufactured by varying vendors and/or can be of the varying types. For example, the HED 102 can be a coffee maker available from Keurig, Inc. of Reading, Mass. In contrast, the HED 108 can be a telephone available from AT&T of San Antonio, Texas. Embodiments of the present invention are not limited in this regard. For example, each of the HEDs 102, 104, 106, 108, 110, 112, 114 can be any household appliance or consumer electronic device.

According to embodiments of the present invention, each of the HEDs 102, 104, 106, 108, 110, 112, 114 is configured to perform a primary function (e.g., making coffee, washing cloths and providing entertainment) that is intended by a designer and/or manufacturer thereof. More particularly, the RED 102 is a coffee maker useful for brewing coffee. The HED 104 is a clock/radio useful for outputting the time and audio associated with radio stations. The HED 106 is a security/surveillance system useful for alerting an owner of danger. The HED 108 is a telephone useful for placing and receiving calls. The HED 110 is an intercom system useful for allowing people in different rooms to talk to each other. The HED 112 is a television useful for viewing television broadcasts. The HED 114 include, but are not limited to, an air conditioning system, a refrigerator, an oven, a microwave, a garage door, a door lock, a window shade device and/or a washing machine. Embodiments of the present invention are not limited in this regard.

Each of the HEDs 102, 104, 106, 108, 110, 112, 114 can be configured to operate in a customized manner. In this regard, the HEDs 102, 104, 106, 108, 110, 112, 114 can be customized to perform secondary functions. The secondary functions are functions different than the primary functions of the RED that were intended by the designer and/or manufacturer thereof For example, the coffee maker 102 can be customized to operate as a humidifier. The telephone 108 and/or clock/radio 104 can be customized to operate as an intercom system and/or a television controller. The television 112 can be customized to operate as a video surveillance system. The intercom system 110 can be customized to operate as a radio. Embodiments of the present invention are not limited in this regard.

The HEDs 102, 104, 106, 108, 110, 112, 114 can also be customized to perform their intended primary functions in accordance with one or more customized operating parameters. For example, the coffee maker 102 can be customized to heat water for a longer period of time than an originally programmed period of time. Embodiments of the present invention are not limited in this regard.

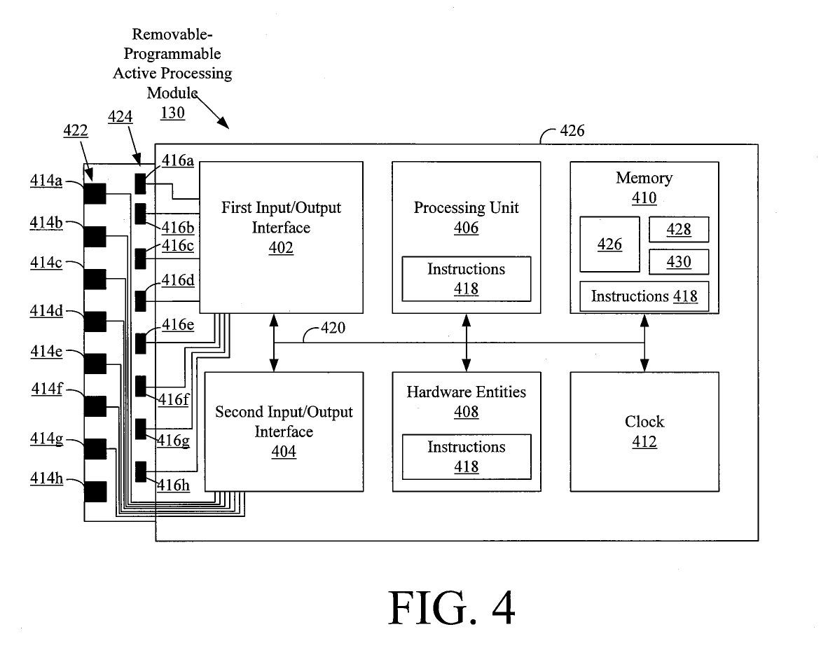

The customizability of each HED 102, 104, 106, 108, 110, 112, 114 is facilitated by a respective removable-programmable active processing module 130, 132, 134, 136, 138, 140, 146. In embodiments of the present invention, one or more of the active processing modules 130, 132, 134, 136, 138, 140, 146 is a removable and programmable active processing module. In this scenario, the active processing modules 130, 132, 134, 136, 138, 140, 146 can be plug-and-play cards. An exemplary embodiment of the active processing module 130, 132, 134, 136, 138, 140, 146 will be described in detail below in relation to FIG. 4. Still, it should be noted that each of the active processing modules 130, 132, 134, 136, 138, 140, 146 includes hardware and/or software configured for enabling the customization of operations of household appliances and consumer electronic devices. In some embodiments of the present invention, the HED may not be communicatively coupled to a domotics network. In this scenario, a user can still activate a secondary function of a household appliance and consumer electronic device by simply inserting an active processing module into the HED.

As shown in FIG. 1, each of the HEDs 102, 104, 106, 108, 110, 112, 114 is communicatively coupled to the central controller 142 via the DN 116. One or more of the HEDs 102, 104, 106, 108, 110, 112, 114 can be configured to communicate information to the central controller 142 regarding the status of the device, available options of the device and/or other information useful for controlling the device.

The DN 116 is generally configured to allow the HEDs 102, 104, 106, 108, 110, 112, 114, 142 to be controlled by a central controller 142. The central controller 142 can include, but is not limited to, a computer workstation, a desktop personal computer system, a laptop personal computer system, or any other general purpose computer processing device. According to embodiments of the present invention, the central controller 142 employs an active processing module 142 for controlling the operations of the HEDs connected thereto via the DN 116. The active processing module 144 can be a plug-and-play device configured to transmit messages to and receive messages from the HEDs 102, 104, 106, 108, 110, 112, 114, 144. In this scenario, automation applications stored in the active processing module 142 are executed at power-up of the active processing module 142 by a processing unit thereof The automation application can include, but are not limited to, in-house multimedia and peripheral sharing applications, home automation applications, security monitoring applications, energy reduction applications and renewable energy management applications. After completion of a power-up routine, the processing unit of the active processing module 142 can send commands to the HEDs 102, 104, 106, 108, 110, 112, 114, 144 coupled to the DN 116. Embodiments of the present invention are not limited in this regard.

As shown in FIG. 1, the DN 116 can have a centralized architecture with a common centralized controller 142 for controlling the operations of the HEDs 102, 104, 106, 108, 110, 112, 114, 142. Alternatively, the DN 116 can have a distributed architecture including a central controller 142 and remote sub-controllers (not shown in FIG. 1) for controlling the HEDs 102, 104, 106, 108, 110, 112, 114, 142. In this scenario, the remote sub-controllers (not shown in FIG. 1) can be located in particular areas of a home (e.g., in a bed room or hallway) or building. The DN 116 can also alternatively have a mixed architecture that is a combination of the centralized and distributed architectures.

The DN 116 is configured to communicate information to and from the HEDs 102, 104, 106, 108, 110, 112, 114, 142 using communication and control wiring, embedded signals in a powerline, Radio Frequency (RF) signals, and/or a combination thereof. The DN 116 can communicate information formatted in accordance with various communication protocols. Such communication protocols include, but are not limited to, IEEE 1394 communication protocols, X-10 communication protocols, BACnet communication protocols, INSTEON® communication protocols, KNX® communication protocols, C-Bus communication protocols, OpenWebNet communication protocols, Universal Powerline Bus (UPB) communication protocols, Universal Plug and Play (UPnP) networking protocols, ZIGBEE® communication protocols. The DN 116 can include one or more translation devices (not shown in FIG. 1) for translating information from one protocol format to another protocol format (e.g., from an X-10 protocol format to a European Installation Bus protocol format).

According to embodiments of the present invention, the DN 116 can include a monitoring and reporting system (not shown in FIG. 1) that maintains records of selected events. The DN 116 can also include remote sensors (not shown in FIG. 1) that are used to turn various devices on and off when motion and/or sound is detected. For example, a remote sensor can be provided to automatically turn on or off lights (not shown in FIG. 1) when motion is detected. A remote sensor can also be provided to turn the television 112 on and off in response to a particular voice command. The DN 116 and/or the central controller 142 can include memory (not shown in FIG. 1) having preset times stored therein. In this scenario, certain HEDs 102, 104, 106, 108, 110, 112, 114, 142 can be turned on or off at the present times. Also, the clock/radio 104 and/or television 112 can be tuned to a particular channel at the preset times. Embodiments of the present invention are not limited in this regard.

The present invention will now be described in more detail in relation to the coffee maker 102 of FIG. 1. Embodiments of the present invention are not limited in this regard. For example, the present invention can be used with any household appliance or other consumer electronic device including an interface for an active processing module 130, 132, 134, 136, 138, 140, 144, 146 as shown in FIG. 1.

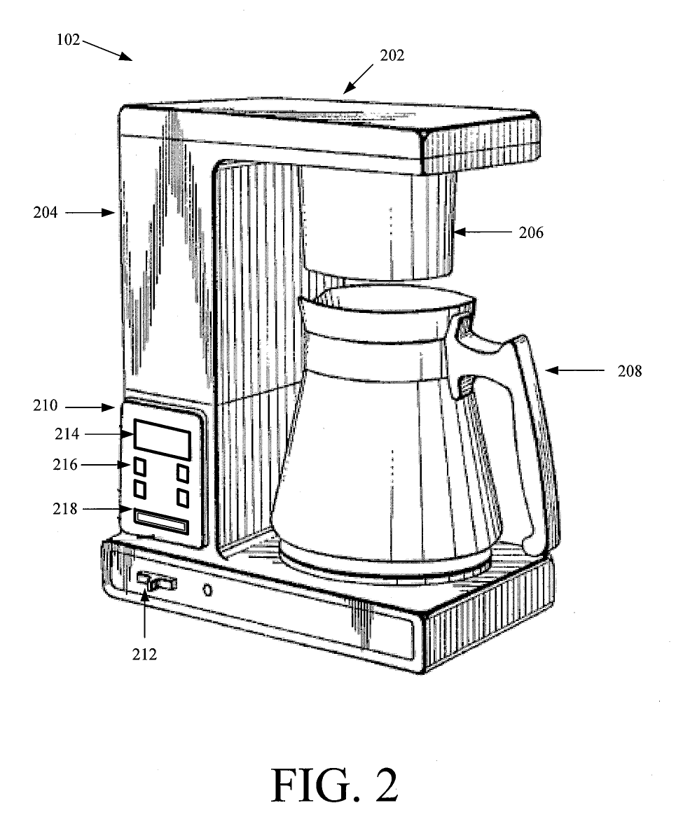

Referring now to FIG. 2, there is provided a schematic illustration of an exemplary embodiment of the coffee maker 102 of FIG. 1 that is useful for understanding the present invention. As shown in FIG. 2, the coffee maker 102 generally includes a housing 202 supporting several components forming a brewer. The components forming the brewer include, but are not limited to, a reservoir 204 for holding water, a filter basket 206 for filtering water through ground coffee beans and a thermal carafe 208. The coffee maker 102 also includes an on/off switch 212 and a Control and Display Panel (CDP) 210. The CDP 210 comprises a display 214, a keypad 216 and a connector 218. The connector 218 is sized and shaped for receiving at least a portion of an active processing module (e.g., the active processing module 130 of FIG. 1). For example, the connector 218 includes an edge connector socket sized and shaped to receive an edge connector of an active processing module (e.g., the active processing module 130 of FIG. 1). Embodiments of the present invention are not limited in this regard. Any type of connector architecture can be used with the present invention without limitation.

According to embodiments of the present invention, the connector 218 is recessed in relation to an exposed surface of the coffee maker 102. In this scenario, the connector 218 is disposed in an insert space (not shown in FIG. 2) sized and shaped for receiving at least a portion of an active processing module. Also, an actuation mechanism (not shown in FIG. 2) can be provided for ejecting the active processing module from the insert space (not shown in FIG. 2). Embodiments of the present invention are not limited in this regard.

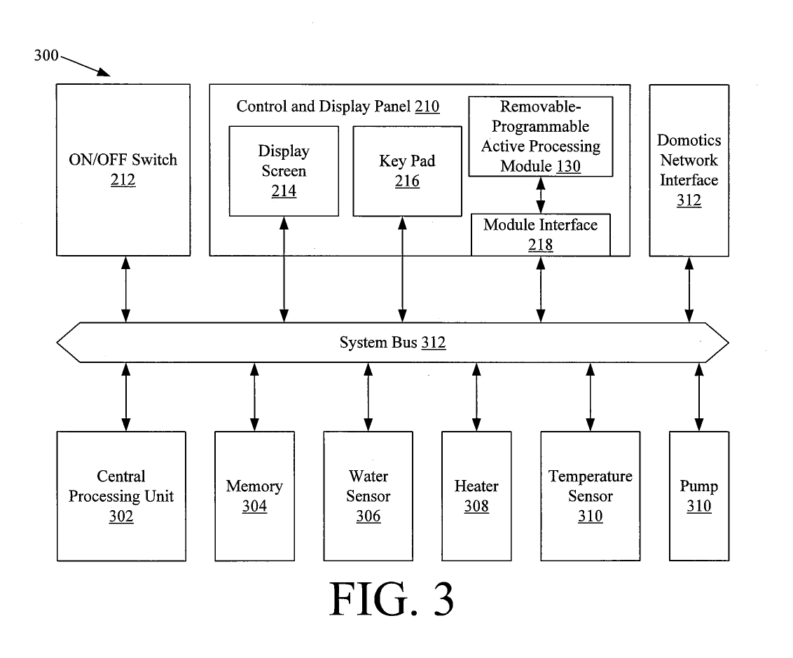

A block diagram of an exemplary circuit 300 of the coffee maker 102 is provided in FIG. 3. As shown in FIG. 3, the circuit 300 includes the on/off switch 212, the CDP 210, a domotics network interface 312, a Central Processing Unit (CPU) 302 and a system bus 312. The circuit 300 also includes a memory 304 connected to and accessible by other portions of the coffee maker 102 through system bus 312. The circuit 300 further includes a water sensor 306, a heater 308, a temperature sensor 310 and a pump 310. The circuit 300 is coupled to the central controller 142 of FIG. 1 through the DN interface 312. The DN interface 312 can send data (for example, status information) to the central controller 142 of FIG. 1. The DN interface 312 can also receive command and control information from the central controller 142 of FIG. 1.

The CPU 302 performs actions involving access to and use of memory 304. Memory 304 includes volatile and/or non-volatile memory. For example, the memory 304 can include, but is not limited to, Random Access Memory (RAM), Dynamic Random Access Memory (DRAM), Static Random Access Memory (SRAM), Read Only Memory (ROM), flash memory, a disk driver and/or other forms of program bulk-storage. One or more device-control application are stored in memory 304 and executed by the CPU 302. The device-control application is generally operative to control operations of the coffee maker 102 such that it performs its primary function using original operating parameter values.

In this regard, the CPU 302 performs actions for controlling the operations of the coffee maker 102 in accordance with a user input and/or a command received from the central controller 142 of FIG. 1. The user input is facilitated by the on/off switch 212 and the CDP 210. The CDP 210 includes a keypad 216 with a plurality of buttons (shown in FIG. 2). The buttons (shown in FIG. 2) are configured to remain in a rest position until pressed, whereupon the buttons are placed in their actuated position until the pressing force is removed. Pressing a button (shown in FIG. 2) causes an electrical signal to be communicated to the CPU 302. In response to the reception of the electrical signal, the CPU 302 controls the operations of the coffee maker 102.

The operations of the coffee maker 102 can also be controlled by the active processing module 130. In this regard, the CDP 210 includes a module interface 218. When the active processing module 130 is inserted into the coffee maker 102, the CPU 302 can be inhibited from controlling operations of the coffee maker 102. In this scenario, the active processing module 130 acts as a new master of the coffee maker 102 in addition to the CPU 302. Also, all communications from the central controller 142 of FIG. 1 are redirected to the active processing module 130. Embodiments of the present invention are not limited in this regard. For example, the operations of the coffee maker 102 can be controlled by the active processing module 130 working in conjunction with the CPU 302.

Notably, the active processing module 130 can be programmed by a user using a computer workstation, a desktop personal computer system, a laptop personal computer system, or any other general purpose computer processing device. This programming can generally involve defining customized values for operating parameters of the coffee maker 102. For example, a user can set a brewing time to a desired duration for a particular application. The user can also develop and/or store a device-control application on the active processing module 130. In this scenario, the device-control application can be operative to cause the coffee maker 102 to perform a secondary function other than its intended primary function. The device-control application can also be operative to cause the coffee maker 102 to perform its primary function using customized values for one or more operating parameters.

A detailed block diagram of an exemplary embodiment of the active processing module 130 is provided in FIG. 4. Notably, the active processing modules 132, 134, . . . , 140, 144, 146 of FIG. 1 are the same as or substantially similar to the active processing module 130. As such, the following discussion of the active processing module 130 is sufficient for understanding the active processing modules 132, 134, . . . , 140, 144, 146 of FIG. 1. Notably, the active processing module 130 may include more or less components than those shown in FIG. 4. However, the components shown are sufficient to disclose an illustrative embodiment implementing the present invention.

The hardware architecture of FIG. 4 represents one embodiment of a representative active processing module 130 configured to execute various types of software programs and applications. For example, the active processing module 130 can execute an operating system, a compiler, a file system and software development applications 426 for facilitating the development and installation of device-control applications 428. The active processing module 130 is also configured to execute device-control applications 428 for controlling an operation of a household appliance and/or other consumer electronic device.

According to embodiments of the present invention, the active processing module 130 is designed so as to be useful in low power applications and/or high performance application. The active processing module 130 is also designed so as to be useful in space sensitive applications. In this regard, it should be understood that the active processing module 130 is sized and shaped in accordance with a particular application. More particularly, the active processing module 130 can have dimensions selected based on die size, thermal dissipation and the packaging technology employed for packaging the electronic components thereof. For example, the active processing module 130 can have the following dimensions: 43 mm by 36 mm; 32 mm by 24 mm; 21 mm by 20 mm; or 11 mm by 15 mm. Embodiments of the present invention are not limited in this regard.

As shown in FIG. 4, the active processing module 130 generally includes a Printed Circuit Board (PCB) 426 with a plurality of electronic components disposed thereon. The electronic components include edge connectors 422, 424, a processing unit 406 and a system bus 420. The electronic components also include a memory 410 connected to and accessible by other portions of active processing module 130 through system bus 420. The electronic components further include Input/Output (I/O) interfaces 402, 404, a clock 412 and hardware entities 408. At least some of the hardware entities 408 perform actions involving access to and use of memory 410. The memory 410 can include volatile and/or non-volatile memory. For example, the memory 410 can include, but is not limited to, Random Access Memory (RAM), Dynamic Random Access Memory (DRAM), Static Random Access Memory (SRAM), Read Only Memory (ROM), flash memory, a disk driver and/or other forms of program bulk-storage.

The I/O interface 404 is communicatively coupled to the edge connector 422. The edge connector 422 comprises a plurality of pads 414a, 414b, 414c, 414d, 414e, 414f; 414g, 414h formed of a conductive material. The pads 414a, . . . , 414h are electrically isolated from each other. The pads 414a, . . . , 414h provide electrical contacts for electrically connecting the active processing module 130 to an external device (not shown in FIG. 1). The pads 414a, . . . , 414h may be recessed or raised relative to a surface of the PCB 426. One or more of the pads 414a, . . . , 414h can be provided for electrically connecting a power source to the active processing module 130.

The I/O interface 404 and edge connector 422 collectively enable the customization of operations for household appliances and electronic consumer devices (e.g., the devices 102, . . . , 114 of FIG. 1). For example, the edge connector 422 is sized and shaped to mate with an edge socket connector of a general purpose computing device (not shown in FIG. 4). Notably, when the active processing module 130 is coupled to the general purpose computing device, the I/O interface 404 is self configurable, i.e., the I/O interface 404 is automatically and selectively configured so as to match with the general purpose computing device in terms of electrical interface and protocol standard. In this regard, the I/O interface 404 can operate as a Secure Digital Input Output (SDIO) interface, a Universal Asynchronous Receiver/Transmitter (UART) interface, an I2C interface and/or a Universal Serial Bus (USB) interface.

The I/O interface 404 enables communication of information from the external device (not shown in FIG. 4) to the active processing module 130, and vice versa. Consequently, a user can access the memory 410 of the active processing module 130 via the external device (not shown in FIG. 4). In this scenario, the user can interact with and control software applications of the active processing module 130. More particularly, the user can develop and install customized device-control applications 428 for causing a household appliance or consumer electronic devices to perform secondary functions other than its intended primary function. The user can also modify or define value for operating parameters of the household appliance or consumer electronic device using the external device (not shown in FIG. 4). In this regard, the external device (not shown in FIG. 4) can read data from the memory 410 and write data to the memory 410 for storage therein.

The operating parameters that a user can customize depends on the type of device the active processing module 130 is intended to control. For example, if the device is a coffee maker 102, then the operating parameters can include, but are not limited to, a temperature parameter, a time parameter, an intensity of a current absorbed by the heater 308 and an intensity of a current absorbed by a pump 310. In contrast, if the device 104, . . . , 114 is a device other than a coffee maker 102, then the operating parameters can include, but are not limited to, a temperature parameter, a time parameter, a frequency parameter, a voltage parameter, a channel parameter, a volume parameter, a mute parameter, an audio output parameter, a video output parameter, display parameters, a start parameter, a stop parameter, motion detection parameters, a power consumption parameter, an energy reduction parameter, a renewable energy management parameter and voice command parameters.

The I/O interface 402 is communicatively coupled to the edge connector 424. The edge connector 424 comprises a plurality of pads 416a, 416b, 416c, 416d, 416e, 416f, 416g, 416h formed of a conductive material. The pads 416a, . . . , 416h are electrically isolated from each other. The pads 416a, . . . , 416h provide electrical contacts for electrically connecting the active processing module 130 to an external device (not shown in FIG. 1). The pads 416a, . . . , 416h may be recessed or raised relative to a surface of the PCB 426. One or more of the pads 416a, . . . , 416h can be provided for electrically connecting a power source to the active processing module 130.

The I/O interface 402 and edge connector 424 facilitate the control of household appliances and electronic consumer devices (e.g., the devices 102, . . . , 114 of FIG. 1) by the processing unit 406. In this regard, the edge connector 424 is sized and shaped to mate with an edge socket connector (e.g., the connector 218 of FIG. 2) of a household appliance and/or other consumer electronic device. The I/O interface 402 enables communication of information from the household appliance and/or other consumer electronic device to the processing unit 406, and vice versa. The information can include, but is not limited to, commands and operating parameter values. The I/O interface 402 can be operative as an Ethernet interface, a Universal Serial Bus (USB) interface, a Serial Advanced Technology Attachment (ATA) interface, a Controller Area Network (CAN) interface, a Joint Test Action Group (JTAG) interface, an Analog to Digital (A/D) interface and/or a Digital to Analog (D/A) interface. The I/O interface 402 is configurable such that it can operate as one or more of the above listed types of interfaces based on power consumption and marketing requirements of the active processing module 130. The I/O interface 402 can also be selectively configured to operate as one or more of the above listed types of interfaces based on the protocol standard employed by a domotics network.

Although each of the edge connectors 422, 424 are shown in FIG. 4 to include eight (8) electrical contacts 414a, . . . , 414h, 416a, . . . , 416h, embodiments of the present invention are not limited in this regard. Each edge connector 422, 424 can include any number of electrical contacts.

Although each of the I/O interfaces 402, 404 has been described to enable the programming of the active processing module 130 or to enable the control of household appliances and electronic consumer devices, embodiments of the present invention are not limited in this regard. For example, either of the I/O interfaces 402, 404 can be configured to interface with a computing device, a household appliance and/or an electronic consumer device.

Hardware entities 408 may include Field Programmable Gate Arrays (FPGAs), microprocessors, Application Specific Integrated Circuits (ASICs) and other hardware. Hardware entities 408 are generally configured for facilitating the development of device-control applications 428 by a consumer or manufacturer of the active processing module 130. In this regard, it should be understood that the hardware entities 408 can access and run software development applications 430 stored in the memory 410 of the active processing module 130. The software development applications 430 are generally operative to perform software development operations and software installation operations. Software development and installation operations are well known to those having ordinary skill in the art, and therefore will not be described herein. The software development applications 430 can include, but are not limited to, a Real Time Operating System (RTOS), a C compiler, a C++ complier, a Java compiler, a debugger, an emulator, a file system, drivers, FPGA tools, an Integrated Development Environment (IDE) and exemplary codes for controlling a household appliance or other consumer electronic device.

The hardware entities 408 are also generally configured to facilitate user-software interactions for defining and/or modifying values for operating parameters of a household appliance and/or other consumer electronic device. In this regard, it should be understood that the hardware entities 408 can access and run parameter setting applications 430 stored in memory 410 of the active processing module 130. The parameter setting applications 428 are generally operative to perform parameter setting operations. The parameter setting operations can involve, but are not limited to, prompting a user to input a value for a particular operating parameter and storing the inputted value in memory 410.

As shown in FIG. 4, the hardware entities 408 can include a computer-readable storage medium on which is stored one or more sets of instructions 418 (e.g., software code) configured to implement one or more of the methodologies, procedures, or functions described herein. The instructions 418 can also reside, completely or at least partially, within the memory 410 and/or within the CPU 406 during execution thereof by the active processing module 130. The memory 410 and the CPU 406 also can constitute machine-readable media.

According to embodiments of the present invention, the active processing module 130 is configured to transmit, receive, repeat and/or initiate messages on the DN 116. The active processing module 130 is re-configurable to match a communication protocol and physical layer of the DN 116. In this scenario, the devices 102, . . . , 114 employing an active processing module 130 are peers which can be controlled by smart home applications. The smart home applications include, but are not limited to, in-house multimedia and peripheral sharing applications, home automation applications, security monitoring applications, energy reduction applications and renewable energy management applications. Embodiments of the present invention are not limited in this regard.

According to other embodiments of the present invention, the active processing module 130 is a plug-and-play device. In this regard, the software 418, 426, 428, 430 stored locally on the active processing module 130 will automatically be executed at power up of the active processing module 130 by the processing unit 406. Thereafter, the processing unit 406 can send commands to the DN 116 and/or receive commands from the DN 116 via the I/O interface 402. Embodiments of the present invention are not limited in this regard.

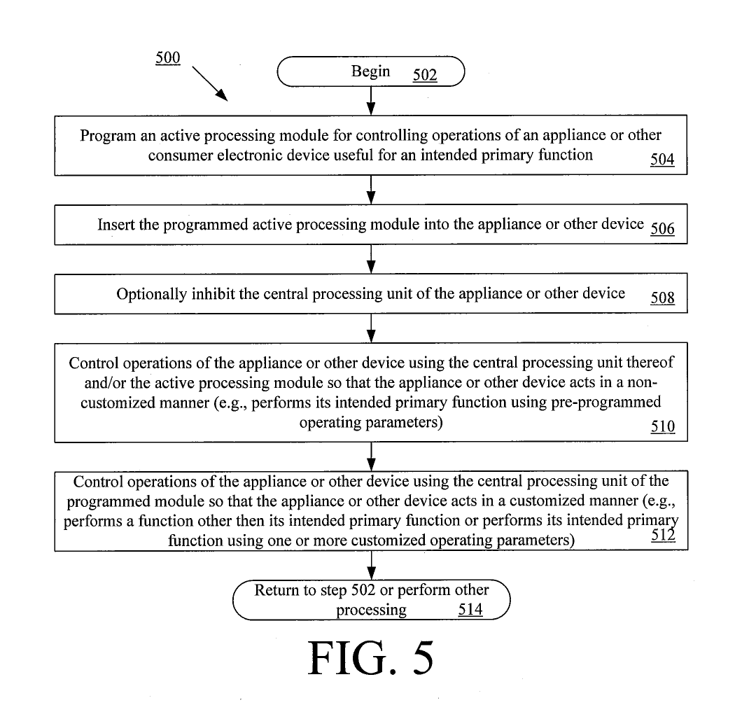

Notably, the home automation system 100 of FIG. 1 implements a method 500 for controlling operations of a household appliance and/or other consumer electronic device. The following FIG. 5 and accompanying text illustrate such a method 500 for controlling operations of a household appliance and/or other consumer electronic device. It should be appreciated, however, that the method 500 disclosed herein is provided for purposes of illustration only and that embodiments of the present invention are not limited solely to the method shown.

Referring now to FIG. 5, there is provided a flow diagram of an exemplary method 500 for controlling operations of a household appliance or other consumer electronic device (e.g., devices 102, . . . , 114, 142 of FIG. 1). As shown in FIG. 5, the method begins with step 502 and continues with step 504. In step 504, an active processing module (e.g., active processing module 130, . . . , 140, 144, 146 of FIG. 1) is programmed for controlling operations of a household appliance or other consumer electronic device that is useful for an intended job (e.g., brewing coffee, washing cloths, washing dishes, providing entertainment and providing security). The active processing module can be programmed using a computer workstation, a desktop personal computer system, a laptop personal computer system, or any other general purpose computer processing device.

The active processing module can be a plug-and-play card. In this scenario, software (e.g., software 418, 426, 428, 430 of FIG. 4) stored in the active processing module is executed at power-up of the active processing module. Thereafter, a consumer or manufacturer can modify an existing device-control application and/or develop a new device-control application using the software executing on the active processing module. The modified and/or new device-control application can be stored in the active processing module. The consumer or manufacturer can also set operating parameter values for a particular household appliance and/or other consumer electronic device using the software executing on the active processing module.

After completing step 504, the method 500 continues with step 506. In step 506, the programmed active processing module (e.g., active processing module 130, . . . , 140, 144, 146 of FIG. 1) is inserted into a household appliance or other consumer electronic device (e.g., device 102, . . . , 114, 142 of FIG. 1). In this regard, it should be emphasized that the household appliance or other consumer electronic device has a connector (e.g., connector 218 of FIG. 2) that mates with a respective connector (e.g., edge connector 424 of FIG. 4) of the active processing module. The household appliance or other consumer electronic device also includes an interface to enable communication with the active processing module.

In an optional next step 508, a central processing unit (e.g., CPU 302 of FIG. 3) is inhibited from controlling one or more operations of the household appliance or consumer electronic device. The central processing unit can be inhibited from controlling operations of an HED in response to the detection of an active processing unit by the HED. In this scenario, the HED can include a sensor or switch for detecting when an active processing module is fully or partially inserted into the HED. The sensor or switch can cause a signal to be communicated to the central processing unit when the active processing module is detected thereby. Alternatively, the central processing unit can be inhibited from controlling operations of an HED by the active processing unit.

Optional step 508 is performed when the active processing module is to control all operations of the HED. In this scenario, all communications to and from the central processing unit of the HED are redirected to the active processing module. However, step 508 may not be performed when the active processing unit is to control device operations in conjunction with the central processing unit of the HED. In this scenario, some of the communications to and from the central processing unit of the household appliance or other consumer electronic device may be redirected to the active processing module.

Upon competing step 506 and/or optional step 508, step 510 and/or step 512 are performed. In step 510, operations of the HED are controlled so that the HED acts in a non-customized manner, i.e., the HED performs it intended primary function using pre-programmed operating parameters. The operations of the HED can be controlled by the central processing unit thereof and/or the active processing module.

In step 512, the operations of the HED are controlled so that the HED acts in a customized manner. For example, the HED performs a function other than its intended function (e.g., a coffee maker acts as a humidifier) or performs its intended function using customized operating parameters (e.g., the coffee maker heats water for a period of time longer than originally specified by the manufacturer). Upon completing step 512, step 514 is performed where the method 500 returns to step 502 or other processing is performed.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A method for controlling a household electronic device (HED) having a processing unit configured to execute first device-control software operative for controlling said HED so that it performs a primary function using original values for a plurality of operating parameters, comprising:
receiving, at said HED, an active processing module configured to execute second device-control software; and
executing, at said active processing module, said second-device control software operative for controlling said HED so that said HED performs said primary function using a customized value for at least one of said plurality of operating parameters or performs a secondary function different than said primary function.

2. The method according to claim 1, further comprising developing said second device-control software using application development software executing on said active processing module.

3. The method according to claim 1, further comprising setting said customized value for at least one of said plurality of customized operating parameters using parameter setting software executing on said active processing module.

4. The method according to claim 1, further comprising connecting said HED to a domotics network.

5. The method according to claim 4, further comprising communicating a command over said domotics network to said active processing module for controlling said HED.

6. The method according to claim 4, wherein said active processing module controls said operations of said HED in response to said command.

7. The method according to claim 1, further comprising inhibiting said processing unit of said HED from controlling at least one operation of said household electronic device.

8. The method according to claim 1, further comprising redirecting communications directed to said processing unit of said HED to said active processing module.

9. The method according to claim 1, further comprising selecting said HED from the group consisting of a household appliance, a home entertainment system, a home security system and a home surveillance system.

10. A household electronic device (HED), comprising:
a first processing unit configured to execute first device-control software operative for controlling said HED so that it performs a primary function using original values for a plurality of operating parameters; and
a removable and programmable active processing module configured to execute second device-control software operative for controlling said HED so that said HED performs said primary function using a customized value for at least one of said plurality of operating parameters or performs a secondary function different than said primary function.

11. The HED according to claim 9, wherein said HED is coupled to a domotics network.

12. The HED according to claim 10, further comprising a domotics network interface configured to receive a command communicated over said domotics network to said HED.

13. The HED according to claim 11, wherein said active processing module is further configured to control said operations of said HED in response to said command.

14. The HED according to claim 9, wherein said active processing module is further configured to inhibit said first processing unit from controlling at least one operation of said HED.

15. The HED according to claim 9, wherein said active processing module is further configured to execute application development software stored in a memory thereof.

16. The HED according to claim 9, wherein said HED is selected from the group consisting of a household appliance, a home entertainment system, a home security system and a home surveillance system.

17. An home automation system, comprising:
a domotics network including at least one controller for controlling a plurality of household electronic devices (HEDs) communicatively coupled to said controller via said demotics network,
at least one household electronic device (HED) of said plurality of HEDs comprising
a first processing unit configured to execute first device-control software operative for controlling said HED so that it performs a primary function using original values for a plurality of operating parameters, and
a removable and programmable active processing module configured to execute second device-control software operative for controlling said HED so that said HED performs said primary function using a customized value for at least one of said plurality of operating parameters or performs a secondary function different than said primary function.

18. The home automation system according to claim 17, wherein said active processing module is further configured to control said operations of said HED in response to a command received from said controller of said domotics network.

19. The home automation system according to claim 17, wherein said active processing module is further configured to inhibit said first processing unit from controlling at least one operation of said HED.

20. The home automation system according to claim 17, wherein said active processing module is further configured to execute application development software stored in a memory thereof.
